(19) United States
(12) Patent Application Publication
(10) Pub. No.: US 2005/0277421 A1
(43) Pub. Date: Dec. 15, 2005

(54) Alarm transmission system and method

(76) Inventor: Vincent Ka-wing Ng, Hong Kong (HK)

Correspondence Address: RABIN & Berdo, PC, 1101 14TH STREET, NW, SUITE 500, WASHINGTON, DC, 20005, US

(21) Appl. No.: 11/149,204

(22) Filed: Jun. 10, 2005

Related U.S. Application Data
(60) Provisional application No. 60/579,283, filed on Jun. 15, 2004.
(60) Provisional application No. 60/647,425, filed on Jan. 28, 2005.

(51) Int. Cl. H04Q 7/20

(52) U.S. Cl. 455/445; 455/417

(57) ABSTRACT

An alarm transmission system and method for summoning assistance in response to a problematic situation, with police, consumer and helper versions. In all versions, a fast data transmission mobile phone is carried by a user, which is capable of transmitting real-time on-site video images (a video call) to a server. In the police version and helper version, the real-time on-site video images are transmitted to a monitoring device, which may cause transmission of the real-time on-site video images to a rescuer communication device or otherwise take action in response to the video transmissions. In the consumer version, the user of the phone will communicate with an inter-active voice response system, which may trigger transmission of the real-time on-site video images to a rescuer communication device. In all cases above, the video calls are recorded live. An innovative testing system is constructed to measure the delay at the video call.

### RELATED APPLICATION

This non-provisional application claims priority from provisional application No. 60/579283, filed on Jun. 15, 2004 and from provisional application No. 60/647 425, filed on Jan. 28, 2005, the disclosures of each of which are incorporated herein by reference in their entirety.

### FIELD OF THE INVENTION

This invention relates generally to personal security and problem solving devices and, more particularly, to a system and method for transmitting, from a hand-held device, video call (real-time on-site video images) on a criminal suspect, or other potentially dangerous or otherwise problematic situation to a suitable monitoring & recording facility for assistance.

### BACKGROUND OF THE INVENTION

Police officers who are responding to a call for assistance may be concerned about the risk of an attack from behind by a criminal or terrorist. An ability on the part of others to watch the officer's back would help to alleviate such fear, and potentially deter such attack. The use of 3G video call to protect police officers at dangerous area forms the backbone of this invention.

Some consumers also face violent crime threat when they return home at night and this invention is modified for their uses. There is common consensus that mobile phone user can obtain better assistance in solving site problem by making video call to the helper. This invention is modified slightly from the police uses to civilian uses.

Finally, solving the delay at mobile-to-fixed 3G video call induce the invention on a testing system which can be set up easily to measure the delay at video call. This testing system can locate the critical components in the delay seen at 3G video call and suggest some possible solutions to the delay.

The case for consumer use of this alarm transmission system as an extra protection against violent crime can be explained further. A common fear on the part of persons live in areas where there is a significant crime threat is that they will become a victim of a violent crime. This fear may be particularly pronounced on the part of those who find themselves in areas that may be poorly lit, unoccupied, or that for some other reason seem to present an opportunity for a criminal to act. In addition, in an era of increased terrorism awareness, citizens are increasingly asked to be on the alert for potentially threatening situations.

The prevalence of cell phones, and the incorporation of GPS (global positioning system) and MPS (mobile positioning system) technology into such devices, has made possible the placing of a 911 call by a person who is the victim of a criminal act and/or who discovers a potentially dangerous situation, and who only has access to a wireless telephone. However, a limitation inherent in this approach is that law enforcement authorities generally discourage or even prohibit the placement of 911 calls by persons who merely fear that a crime may occur, but where there has been no criminal act and where such an act does not appear to be sufficiently imminent. By that point, the 911 call may no longer be possible or, even if placed, may be too late to prevent a crime from occurring. Moreover, because a person placing a 911 call may have waited too long or may be under too much emotional stress to provide significant identifying information concerning a criminal suspect or possible terror threat, a 911 call may not be of substantial assistance to law enforcement authorities in solving a crime where the perpetrator successfully escapes the scene.

Mobile phones also have several other drawbacks. Many people such as children, the elderly, or people who are lost, do not know who to call in certain situations. Children, tourists, and the like may have a cell phone when they become lost, but these people have no idea who to call. Even if a child calls a parent, the parent will have no idea where the child is or how to help the child find the proper location. Likewise, an elderly person or an individual may feel slightly ill, but may be afraid to call 911 since they don't feel that they are sufficiently ill to warrant a 911 call. Therefore, the system is designed to record the video call while a server is searching an available helper for the mobile phone user.

The present invention is directed to a system and method that overcomes the above problems. In general terms, and while capable of being adapted and modified in various ways as described herein, the present invention permits a person to transmit a live video call from a 3G, 3.5G, 4G, or Super 3G mobile phone over a network, showing real-time on-site images of a potential criminal suspect, terror threat or other problematic situation. That call, or at least video images recorded from that call, may ultimately be routed to a police officer or other rescuer. Delay between transmission of the video images and their receipt should be limited, and delays of less than half a second are most preferred.

Solving delay at mobile-to-fixed 3G video call started with the requirement of less than 0.5 second delay at 3G video for police uses of the alarm transmission system. Delays at mobile-to-fixed (also called fixed-mobile) 3G video call is obviously experienced under 3 Hong Kong 3G network and SingTel Mobile 3G network (trial launch). Delay under 3 Hong Kong 3G network is around 2 seconds. Delay of fixed-mobile video call under SingTel Mobile 3G network is longer than 2 seconds. Solutions must be found to solve such delay at mobile-to-fixed 3G video call for the “police version” and “helper version” of the alarm transmission system to be useful in real life.

Some IT people think the solution to this delay at fixed-mobile 3G video call may lie at faster data transmission rate at the mobile network. That is, upgrading from 3G (WCDMA) to 3.5G (HSDPA/HSUPA), 4G (WiMax) or Super 3G will be needed. But, such thinking is proved to be wrong after the inventor measured the delay of the mobile-to-fixed 3G video call at a PC (fixed terminal of the fixed-mobile 3G video call) installed with the anti-virus software of different virus scanning rate.

The inventor also observes that the delay at 3G video call between 3G handsets is less obvious, less than one second. This should imply the video gateway at Three Hong Kong 3G is fast enough to support less than one second delay. Mobile-to-Fixed 3G video call require disabling of the firewall of many anti-virus software (including Trend PC-cillin) and other anti-spyware software. This means firewall and some anti-virus software is scanning on the video stream sent through the 3G video call. As a result, speeding up the anti-virus software should reduce the delay at mobile-to-fixed 3G video call. Trend PC-cillin, Symantec Norton Anti-virus and McAfee VirusScan are common anti-virus software in Hong Kong and Singapore. Slower scan engines of these three popular anti-virus software may be part of the cause of delay commonly experienced in mobile-to-fixed 3G video call in Hong Kong and Singapore.

After inventing two simple testing methods on image and sound delay (based on pressing the start/stop button of the timer), the inventor finds ways to reduce the delay in mobile-to-fixed 3G video call to around 0.5 second (i.e. half a second). Delay of sound at fixed-to-mobile 3G video call is only around 0.5 second, which is important for sending advice to handset user. However, delay of video image at fixed-to-mobile 3G video call is obviously longer, can be ranging from 0.9 second to 1.8 second.

### BRIEF DESCRIPTION OF THE EMBODIMENTS

In accordance with an embodiment of the present invention, an alarm transmission system, for summoning assistance in response to a problematic situation is disclosed. The system comprises:
a) a mobile device (including mobile phone, PDA mobile phone etc.) which has fast data transmission rate, e.g. 3G, HSDPA/HSUPA, WiMax etc., for transmitting video call (real-time on-site video images) of the problematic situation;
b) a server in communication with the mobile device, which receives and records the video call from the mobile device, and then hunts and connects an available monitoring device from a list of pre-defined monitoring devices;
c) a list of pre-defined monitoring devices, one of which receives the video call from the server that was originally transmitted by the mobile device, and instructs the server to send the recorded video call and photos to a rescuer control room email terminal;
d) a rescuer control room email terminal, which receives the recorded video call and photos sent by the server;
e) a rescuer communication device, which receives the recorded video and photos from the rescuer control room email terminal that were originally transmitted by the mobile device.

When the mobile device in the system is carried by a law enforcement officer, it is called the “police version” of the system. When the mobile device in the system is carried by a civilian, it is called the “helper version” of the system. “Police version” of the system usually requires higher standard of the system performance, includes better and more stable images at the video call.

The above mobile device is equipped with a location based service in all cases. The above monitoring device is further provided with a function of recording the video call while assistance is provided via the monitoring device to the mobile device, as an alternative device to perform the recording video call function of the server.

The monitoring device also has a fast anti-virus software to enable 0.5 second or less delay at the video call. One convenient way to choose the suitable anti-virus software is picking the fastest anti-virus software, which virus scanning rate is the highest as measured by executable throughput (KB/sec) or which virus scan time (second) on executables is the lowest.

In accordance with another embodiment of the present invention, an alarm transmission system for summoning assistance in response to a problematic situation, which comprises:
a) a mobile device for transmitting video calls of the problematic situation;
b) a server in communication with the mobile device, which receives and records the video calls from the mobile device;
c) an interactive voice response system, which is in communication with the server and the mobile device, and which instructs the server to send the recorded video call and photos to a rescuer control room email terminal;
d) a rescuer control room email terminal, which receives the recorded video call and photos from the server that were originally transmitted by the mobile device; and,
e) a rescuer communication device, which receives the recorded video call and photos from the rescuer control room email terminal.

In the above system, the mobile device is carried by a civilian and it is called “consumer version” of the system. The mobile device of the above system is also equipped with a location based service.

In accordance with a further embodiment of the present invention, a method for transmitting an alarm is disclosed. The method, can be called “police version” or “helper version”, comprises:
a) enabling transmission of video calls from a mobile device to a server;
b) enabling receiving and recording of the video calls by the server;
c) enabling hunting and connecting an available monitoring device from a list of pre-defined monitoring devices by the server for the mobile device;
d) enabling transmission of the video call from the server to the monitoring device;
e) enabling transmission of the recorded video call and photos from the server or the monitoring device to the rescuer control room email terminal, following action by the monitoring device; and,
f) enabling transmission of the recorded video call or photos from the rescuer control room email terminal to the rescuer communication device.

When the mobile device is carried by a law enforcement officer in the above method, it is called the “police version” of the method. When the mobile device is carried by a civilian in the above method, it is called the “helper version” of the method. At the “helper version” of the method, the civilian registers the list of pre-defined monitoring devices or helper communication devices with an operator of the server.

In accordance with another embodiment of the present invention, an alarm transmission method for summoning assistance in response to a problematic situation is disclosed, comprising:
a) enabling transmission of video calls from a mobile device to a server;
b) enabling recording of the video call by the server;
c) enabling communication between an inter-active voice response system and the mobile device through the server, following the transmission of video calls from the mobile device to the server; and,
d) enabling transmission of the recorded video calls and photos to a rescuer control room email terminal, following action by one of the mobile device and the inter-active voice response system;
e) enabling transmission of the recorded video call and photos from the rescuer control room email terminal to a rescuer communication device.

The mobile device in this method is carried by a civilian and this method is called the “consumer version” of the alarm transmission method.

In accordance with another embodiment of the present invention, a testing system for measuring the delay at the video call at the “police version” and “helper version” of the alarm transmission system is disclosed. It comprises:
a) a sending-video-call-signal device, selected from the group consisting of a test mobile device, a test helper communication device, or a test monitoring device;
b) a receiving-video-call-signal device, selected from the group consisting of a test mobile device, a test helper communication device, or a test monitoring device;
c) a test network, which is a network to be tested before it is used as the fast data transmission mobile network of the system;
d) a test server, which is a server to be tested before it is used in this alarm transmission system; and,
e) a stop watch, which measures to 0.01 second.

In accordance with another embodiment of the present invention, a testing method for measuring the delay of video image at the video call of the “police version” and “helper version” of the alarm transmission system is disclosed. It comprises:
1) placing the sending-video-call-signal device and the receiving-video-call-signal device close to each other, and, moving an item in front of the camera of the sending-video-call-signal device;
2) pressing the start button of the time measuring device when the item is moved in front of the sending-video-call-signal device, and, watching the screen of the receiving-video-call-signal device;
3) pressing the time measuring device of the time measuring device when the item appears on the screen of the receiving-video-call-signal device, marking down the reading shown on the time measuring device, and resetting the stop watch to zero;
4) repeating the above steps a number of times until pressing of the start button of the time measuring device exactly matches the time when the item is moved in front of the sending-video-call-signal device, and, pressing of the stop button of the time measuring device exactly matches the time when the item appear on the screen of the receiving-video-call-signal device;
5) averaging out ten stable readings marked down from the time measuring device, and, treating the average as the delay of video image at the video call.

In accordance with another embodiment of the present invention, a testing method for measuring the delay of sound at the video call of the “Police version” and “Helper version” of the alarm transmission system is disclosed. It comprises:
1) placing the sending-video-call-signal device and the receiving-video-call-signal device close to each other;
2) plugging the earphone of the receiving-video-call-signal device at one ear, and, putting aside the microphone of the receiving-video-call-signal device (or turning off the microphone of the receiving-video-call-signal device);
3) holding the microphone of the sending-video-call-signal device near the mouth, and ,putting aside the earphone of the sending-video-call-signal device;
4) saying a simple word close to the microphone of the sending-video-call-signal device, and, pressing the start button of the time measuring device when the word is said to the microphone of the test mobile device;
5) hearing this simple word from the earphone of the receiving-video-call-signal device, and, pressing the time measuring device of the stop watch when the simple word is heard from the earphone of the receiving-video-call-signal device;
6) marking down the time shown on the time measuring device, and, resetting the stop watch to zero;
7) repeating the above steps a number of times until pressing of the start button of the time; measuring device exactly matches the time when the simple word is said to the microphone, and, pressing of the stop button of the time measuring device exactly matches the time when the simple word is heard at the earphone;
8) averaging out around ten stable readings marked down from the time measuring device, and, treating the average as the delay of sound at the video call.

The above testing system and testing methods also lead to the discovery of the major cause of the delay of 2 seconds or more experienced at mobile-to-fixed video call currently. This discovery further leads to the another discovery that the fastest anti-virus software currently available in the market will enable 0.5 second or less delay at mobile-to-fixed 3G video call.

Firewall can block video signal reaching video call signals from reaching the monitoring device. Firewall can also prevent mobile device outside the firewall to locate the monitoring device and, in effect, block the mobile-to-fixed video call. One solution for skipping the firewall is using mobile data card, e.g. 3G or WiMax data card, on notebook PC or PC. The delay at video call is also measured for using 3G data card as broadband Internet access on notebook PC.

### BRIEF DESCRIPTION OF THE DRAWINGS

FIG. 1 is a block diagram illustrating basic components of a system consistent with an embodiment of the present invention, referred to herein as the “police version” or “helper version” of the alarm transmission system.

FIG. 2 is a block diagram illustrating basic components of a system consistent with an embodiment of the present invention, referred to herein as the “consumer version” of the alarm transmission system.

FIG. 3 is a block diagram illustrating basic components of a testing system consistent with an embodiment of the present invention.

FIG. 4 is a flow diagram consistent with an embodiment of the present invention, primarily adapted for use by police, referred to herein as the “police version” of the alarm transmission method.

FIG. 5 is a flow diagram consistent with another embodiment of the present invention, for use by civilians and their helpers, referred to herein as the “helper version” of the alarm transmission method.

FIG. 6 is a flow diagram consistent with an embodiment of the present invention, primarily adapted for use by civilians who do not want to contact a helper, referred to herein as the “consumer version” of the alarm transmission method.

### DETAILED DESCRIPTION OF THE PREFERRED EMBODIMENTS

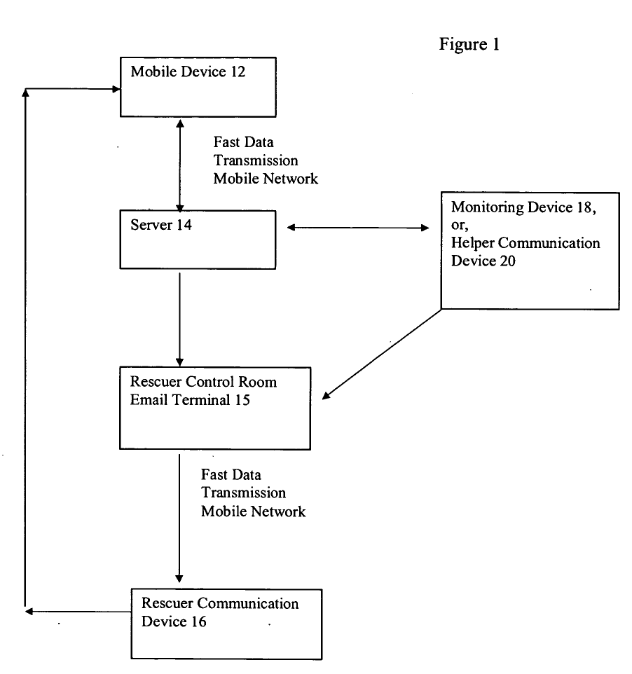

Referring first to FIG. 1, the components of an alarm transmission system (hereinafter system) consistent with an embodiment of the present invention are shown. In this embodiment, the components of the system include a 3G, 3.5G, 4G or Super 3G mobile device 12, a server 14 in communication with the mobile device 12 via a mobile network, a monitoring device 18 in communication with server 14 via the network, a rescuer control room email terminal 15 in communication with the server via a network, a rescuer communication device 16 in communication with the rescuer control room email terminal 15 via a network. The rescuer communication device 16 may also be a 3G, 3.5G,4G, or Super 3G mobile device, a notebook computer, PDA phone, or other suitable device.

The fast data transmission rate mobile device and mobile network for transmitting video call (real-time on-site video images) on the problematic situation, are usually defined as: 3G (WCDMA, CDMA 2000 EV-DO, TD-SCDMA), 3.5G (HSDPA, HSUPA, CDMA 2000 EV-DV), WiMax. (also called 4G). Super 3G was just announced by NTT Docomo etc in January 2005, with first stage of development to be completed in 2007. (While not preferred, it should be noted that GPRS, also called 2.5G, using MMS photo may also be utilized as the mobile device 12. It should be noted that GPRS has much slower data speed and cannot support real-time video call.)

The server 14 receives and records the video call from the mobile device and then hunts and connects an available monitoring device from a list of pre-defined monitoring devices. There is a list of pre-defined monitoring devices 18, one of which receives the video call from the server that was originally transmitted by the mobile device, and instructs the server to send the recorded video call and photos to a rescuer control room email terminal. There is a rescuer control room email terminal 15, which receives the recorded video call and photos sent by the server. A rescuer communication device 16 receives the recorded video and photos from the rescuer control room email terminal 15, which were originally transmitted by the mobile device.

When the mobile device 12 is carried by a law enforcement officer, the system is called “police version” of the alarm transmission system. When the mobile device in the system is carried by a civilian, the system called the “helper version” of the alarm transmission system. The “police version” of the system usually requires higher standard of the system performance, includes better and more stable images at the video call.

At both the “police version” and “helper version” of the system, the mobile device 12 has a location based service and includes a video call processing power which enables 0.5 second or less delay at the video call, a data uplink speed which enables 0.5 second or less delay at the video call and a camera which can takes video images for the video call. In addition, the mobile device 12 is connected to the server 14 by a mobile network, which enables high speed data transmission for supporting video call in areas where the mobile device is used and allows the mobile-to-fixed video call with delay of 0.5 second or less, as measured by the testing system as described below.

The server 14 of the system a recording software which copies the video call signals while the video call is transmitted to the monitoring device, and causes 0.2 second or less delay of video signals in transmitting the video call. The server 14 has an anti-virus software which enables 0.2 second or less delay of the video call signals in transmitting the video call. The server 14 also has a firewall which enables 0.2 second or less delay of the video call signals in transmitting video call.

In addition, the server 14 has an IP PBX function to hunt and connect an available monitoring device from the list of pre-defined monitoring device for the mobile device. In this server, the recording software copies the video call signals while it works with a mobile-to-fixed video gateway at a mobile network operator, with a web server at web-based video call, or, with a video conference gatekeeper at IP based video call. This server 14 also contains an anti-virus software which has a fast virus scanning rate, in terms of executable throughput, and enable 0.2 second or less delay in transmitting the video call.

The monitoring device 18 of the system can be: a PC, a client PC, a notebook PC, an IP softPhone, or, an IP video phone. At both the “police version” and the “helper version” of this system, the monitoring device can be replaced by a helper communication device 20, which has same function as the mobile device 12 of the system.

At both “police version” and “helper version” of the alarm transmission system, the monitoring device 18 has a camera which takes video images for the video call, an anti-virus software which enables 0.5 second or less delay at the video call, a firewall which allows a video call stream to reach the monitoring device and enables 0.5 second or less delay at the video call, a video conferencing software which holds the video call, a CPU which enables 0.5 second or less delay at the video call, a memory which enables 0.5 second or less delays at the video call, a broadband Internet access which enables 0.5 second or less delay at the video call.

At the “helper version” of the system, the monitoring device 18 has a recording software which copies video signals of the video call sent to the monitoring device. This recording software enables copying the H.323 or SIP signal of the video call signals of the video call, with delay of 0.5 second or less at the video call, as measured by the testing system as described below. The above recording software of this monitoring device may also enable capturing screen of the video conferencing software and recording the video call sound signal by capturing the sound track of the monitoring device, with delay of 0.5 second or less at the video call, as measured by the testing system as described below.

A screen capturing software for recording the video call on NetMeeting on the monitoring device 18 comprises three steps. First step is initiating “Audio and Video Conference Recorder” of Virtual Desk. Second step is selecting “best video call quality” and “Microsoft Video 1” format at Options Menu of “Audio and Video Conference Recorder”. The third step is start recording video call by capturing screen of the NetMeeting video Windows. The above recorded video call is compressed to reduce the size of the recorded video file, and, frames of the recorded video call are extracted to still photos, before the recorded video call and frames are sent out. A compression software works efficiently on the recorded video call is Windows Media Encoder, published by Microsoft. Video call recorded by Audio and Video Conference Recorder can be compressed by Windows Media Encoder by selecting “WM 8 format at 250 Kbps speed”.

The monitoring device 18 also has a fast anti-virus software to enable 0.5 second or less delay at the video call. One convenient way to choose the suitable anti-virus software is picking the fastest anti-virus software, which virus scanning rate is highest as measured by executable throughput (KB/sec) or which scan time (second) on executables is lowest.

At the monitoring device 18, the fast anti-virus software can be chosen by picking an anti-virus software which virus scanning rate reaches: executable throughput at 7000 KB/sec or above, or, executable throughput at less than 7000 KB/sec but still enable 0.5 second or less delay at the video call. Alternatively, the anti-virus software can be chosen by picking an anti-virus software which has: a scan time of 39 seconds or below on executables, or, a scan time of more than 39 seconds on executables but still enable 0.5 second or less delay at the video call.

At the monitoring device 18, the firewall enables the video call signals to reach the video conferencing software, with 0.5 second or less delay at the video call at the monitoring device, and allows a fixed virtual IP address or true IP address to access the Internet.

At the monitoring device 18, the broadband Internet access is based on a fixed-line broadband, wireless WAN (Wide Area Network), or a wireless broadband access. This broadband access uses a true IP address or fixed virtual IP address to access Internet and allows either 1 second or less delay at the video call when the wireless broadband access can achieve a data rate of 384 Kbps, 1 to 0.5 second delay at the video call when the broadband access can achieve a data rate between 384 Kbps and 3 Mbps, or, 0.5 second or less delay at the video call when the broadband Internet access can achieve a data speed of 3 Mbps or more.

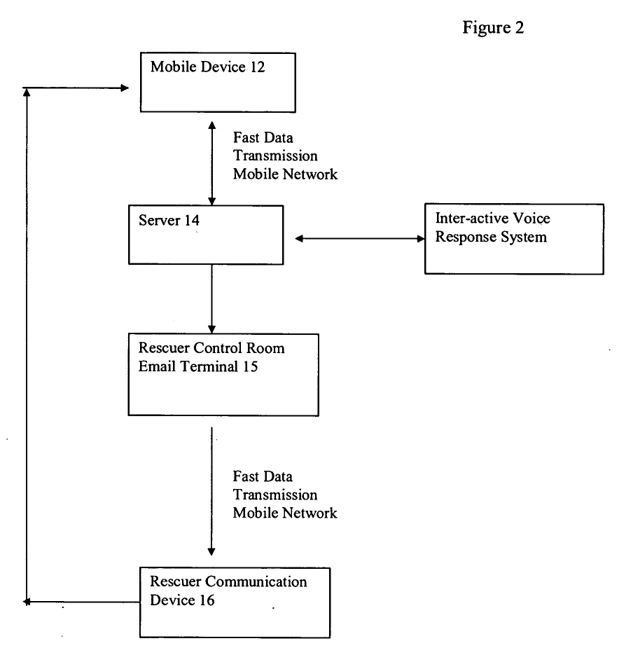

Referring to FIG. 2, the components of an alarm transmission system (hereinafter system) consistent with another embodiment of the present invention are shown. In this embodiment, the components of the system include a 3G, 3.5G, 4G, Super 3G mobile device 12, a server 14 in communication with the mobile device 12 via a mobile network, an interactive voice response system in communication with the mobile device 12 via the server 14, a rescuer control room email terminal 15 in communication with the server 14 via a network, and a rescuer communication device in communication 16 with the rescuer control room email terminal 15 via a mobile network. The rescuer communication device 16 may also be a 3G, 3.5G, 4G, or Super 3G mobile device, a notebook computer, PDA phone, or other suitable device.

In this system, the mobile device 12 transmits video calls of the problematic situation to a server 14, which receives and records the video calls from the mobile device. Then, an interactive voice response system instructs the server to send the recorded video call and photos to a rescuer control room email terminal 15, based on the instruction of the mobile device 12. The rescuer control room email terminal 15 receives the recorded video call and photos from the server that were originally transmitted by the mobile device and send the recorded video call and photo to the rescuer communication device 16.

In the above alarm transmission system, the mobile device 12 is carried by a civilian and it is called “consumer version” of the system. The mobile device 12 is also equipped with a location based service. The above interactive voice response system and recording video call function can be combined together in a way that a three-party video conference is held on the mobile device, with first party as mobile device and the other two parties as the recording video call system and the interactive voice response system.

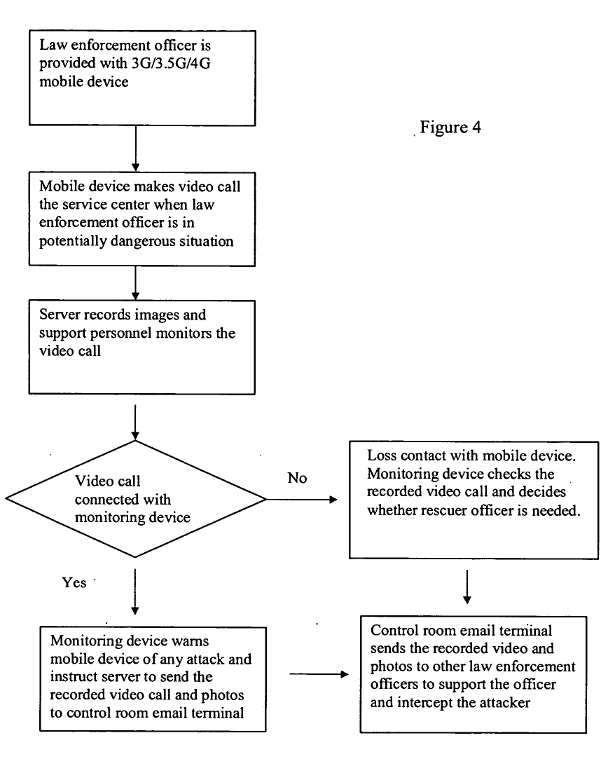

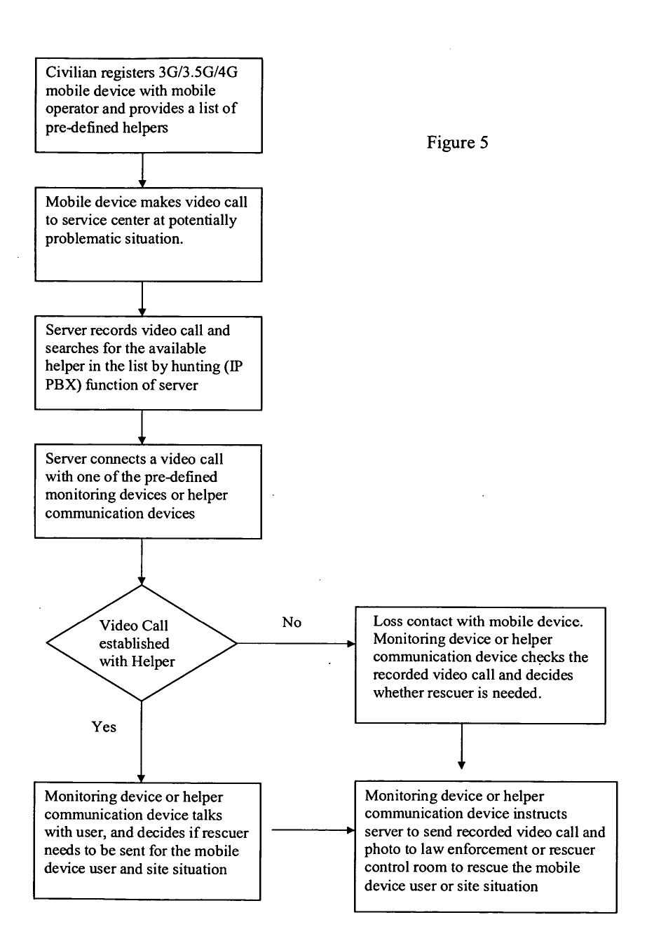

Referring to FIGS. 4 and 5, the steps of a method of transmitting an alarm (hereinafter method), consistent with an embodiment of the present invention are shown. The steps of this method include:
1) enabling transmission of video calls from a mobile device to a server,
2) enabling receiving and recording of the video calls by the server;
3) enabling hunting and connecting an available monitoring device from a list of pre-defined monitoring devices by the server for the mobile device;
4) enabling transmission of the video call from the server to the monitoring device;
5) enabling transmission of the recorded video call and photos from the server or the monitoring device to the rescuer control room email terminal, following action by the monitoring device; and,
6) enabling transmission of the recorded video call or photos from the rescuer control room email terminal to the rescuer communication device.

The above method enables communication between the mobile device and the rescuer communication device. This method also enables determination of a location of the mobile device and communicating the location to the rescuer communication device. When the mobile device is carried by a law enforcement officer in the above method, it is called the “police version” of the method, as presented in FIG. 4. When the mobile device is carried by a civilian in the above method, it is called the “helper version” of the method, as presented in FIG. 5. At the “helper version” of this method, the civilian registers the list of pre-defined monitoring devices or helper communication devices with an operator of the server.

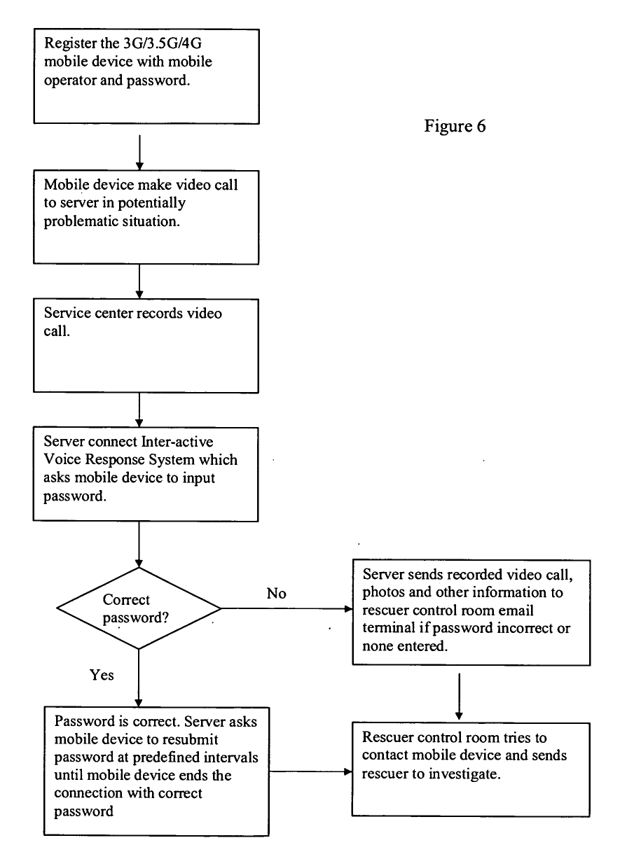

Referring to FIG. 6, the steps of a method of transmitting an alarm (hereinafter method), consistent with an embodiment of the present invention are shown. The steps of this method include:
1) enabling transmission of video calls from a mobile device to a server,
2) enabling recording of the video call by the server;
3) enabling communication between an inter-active voice response system and the mobile device through the server, following the transmission of video calls from the mobile device to the server; and,
4) enabling transmission of the recorded video calls and photos to a rescuer control room email terminal, following action by one of the mobile device and the inter-active voice response system;
5) enabling transmission of the recorded video call and photos from the rescuer control room email terminal to a rescuer communication device.

In the above method, the mobile device is carried by a civilian and it is called the “consumer version” of the method. The above alarm transmission method facilitates communication between the mobile device and the rescuer communication device. This method also comprises enabling determination of a location of the mobile device and communicating the location to the rescuer communication device.

The above method comprises enabling the inter-active voice response system to prompt the user of the mobile device to for a password to be entered. This method further comprises enabling the inter-active voice response system to prompt the user of the mobile device multiple times for a password to be entered. This method also comprises enabling transmission of recorded video call and photos to the rescuer control room email terminal when at least one of a wrong password is entered in response to the prompt or no password is entered in response to the prompt.

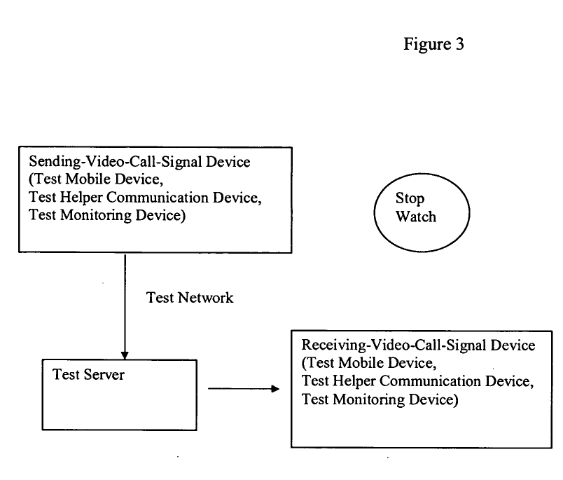

Referring to FIG. 3, the components of a testing system for measuring the delay of the video call at the “police version” and “helper version” of the alarm transmission system (hereinafter system) consistent with an embodiment of the present invention are shown. In this embodiment, the components of the system include a sending-video-call-signal device, a test network which is a fast data transmission rate mobile network, a test server which is in communication with the sending-video-call-signal device via the test network, and a receiving-video-call-signal device which is in communication with the test server via a broadband network.

The sending-video-call-signal device is selected from the group consisting of a test mobile device, a test helper communication device, or a test monitoring device. The receiving-video-call-signal device is selected from the group consisting of a test mobile device, a test helper communication device, or a test monitoring device. The test network is a network to be tested before it is used as the fast data transmission mobile network of the alarm transmission system, as described above. The test server is a server to be tested before it is used in this alarm transmission system and a stop watch which measures to 0.01 second.

In the above testing system, the test mobile device is constructed by plugging a hand-free headset to earphone socket of the mobile device of this alarm transmission system or, connecting a wireless headset to the mobile device of this system. The test helper communication device is constructed by plugging a hand-free headset to the earphone socket of the helper communication device of the “helper version” of this alarm transmission system, or, connecting a wireless headset to the helper communication device. The test monitoring device of this testing system is constructed by connecting a earphone to the monitoring device of the alarm transmission system so that sound output of the monitoring device is channeled to the earphone and then connecting a small microphone to the monitoring device of the alarm transmission system so that all sound input of the monitoring device is channeled to the small microphone. Alternatively, plugging an earphone to a microphone socket of the monitoring device of the alarm transmission system can also cut off the sound input of the monitoring device.

In accordance with another embodiment of the present invention, a testing method for measuring the delay of video image at the video call of the “police version” and “helper version” of the alarm transmission system is disclosed. It comprises:
1) placing the sending-video-call-signal device and the receiving-video-call-signal device close to each other, and, moving an item in front of the camera of the sending-video-call-signal device;
2) pressing the start button of the time measuring device when the item is moved in front of the sending-video-call-signal device, and, watching the screen of the receiving-video-call-signal device;
3) pressing the time measuring device of the time measuring device when the item appears on the screen of the receiving-video-call-signal device, marking down the reading shown on the time measuring device, and resetting the stop watch to zero;
4) repeating the above steps a number of times until pressing of the start button of the time measuring device exactly matches the time when the item is moved in front of the sending-video-call-signal device, and, pressing of the stop button of the time measuring device exactly matches the time when the item appear on the screen of the receiving-video-call-signal device;
5) averaging out ten stable readings marked down from the time measuring device, and, treating the average as the delay of video image at the video call.

In accordance with another embodiment of the present invention, a testing method for measuring the delay of sound at the video call of the “Police version” and “Helper version” of the alarm transmission system is disclosed. It comprises:
1) placing the sending-video-call-signal device and the receiving-video-call-signal device close to each other;
2) plugging the earphone of the receiving-video-call-signal device at one ear, and, putting aside the microphone of the receiving-video-call-signal device (or turning off the microphone of the receiving-video-call-signal device);
3) holding the microphone of the sending-video-call-signal device near the mouth, and putting aside the earphone of the sending-video-call-signal device;
4) saying a simple word close to the microphone of the sending-video-call-signal device, and, pressing the start button of the time measuring device when the word is said to the microphone of the test mobile device;
5) hearing this simple word from the earphone of the receiving-video-call-signal device, and, pressing the time measuring device of the stop watch when the simple word is heard from the earphone of the receiving-video-call-signal device;
6) marking down the time shown on the time measuring device, and, resetting the stop watch to zero;
7) repeating the above steps a number of times until pressing of the start button of the time; measuring device exactly matches the time when the simple word is said to the microphone, and, pressing of the stop button of the time measuring device exactly matches the time when the simple word is heard at the earphone;
8) averaging out around ten stable readings marked down from the time measuring device, and, treating the average as the delay of sound at the video call.
   Measuring the Delay at Fixed-Mobile 3G/3.5G/4G Video Call

As noted above, it is desired to minimize to the extent possible the delay between the transmission of a video call (real-time on-site video images) from the mobile device 12 and their ultimate viewing, whether on a helper communication device 20 or monitoring device 18. For example, it has been observed that a video call between a 3G handset and a PC (or an IP phone) has delay, even though the image and voice are synchronized. That is, both the image and sound played on the PC (or IP phone) are not real time.

The delay on a video call between 3G handsets is less obvious, because the delay can be reduced to around 0.5 second when the video call is made through better 3G handset models. To reduce this delay in mobile-to-fixed 3G video call to around 0.5 second, it has been determined that it is preferred to provide fastest anti-virus software (or faster anti-virus software which can enable a 0.5 sec delay at the video call) on the PC (notebook PC, wireless PDA, or IP softphone). If the delay in mobile-to-fixed 3G video call can be reduced to 0.5 second (half a second) or less, the various embodiments of the system of the present invention will be usable in most situations in real life.

It is noted that in the transmission of a video call (real-time on-site video images) from a 3G phone to a receiving device (IP phone, PC, mobile device, etc.) these components take action in the following sequence:
1. 3G handset camera captures video image and the mouthpiece captures sound;
2. 3G handset CPU processes the video image and sound and then sends them out;
3. 3G mobile operator's network transmits the video image and sound in digital format;
4. 3G mobile operator's video gateway processes the video image and sound;
5. Video image and sound are sent to the receiving device through the Intemet;
6. The fixed terminal (monitoring device) processes the video image and sound, including anti-virus and video conference software processing.

It is noted that a fixed-to-mobile 3G video call would go through the same steps, with the process starting from the fixed terminal, and the capturing of the video image by webcam and the sound by microphone. Some anti-virus software may also scan the video call signals before sending them out through Intemet to the mobile operator's video gateway.

It is noted that delay in performance of any of the above six steps will cause delay in transmitting video images and sound between the two users of a mobile-fixed 3G video call.

Testing has shown that the current delay experienced at a mobile-fixed 3G video call under Three Hong Kong 3G network is mainly caused by processing delay at the fixed terminal, e.g. anti-virus software or webcam delay.

Testing of delay in transmission of a video call was conducted using a variety of 3G handsets. During such testing, it was determined that an LG 8120 3G handset can send out a video call to a Motorola A925 3G handset with around a 0.7 second delay. Testing also showed that the Motorola A925 handset would send a video call to the LG 8120 handset with 1.1 second delay.

The delay in transmission receipt was measured by putting the LG and Motorola handsets close together, and having a tester move one finger over the first handset's camera. The tester would then begin timing at this moment, and then watch the screen of the second handset and stop the timer once the finger image appeared on the screen of the second handset.

The testing suggested that the LG 8120 handset would be preferred, over the Motorola A925 handset. The LG 8120 should have shorter delay in transmitting a video call than Motorola A925 in a 3G video call. This indicates that there is faster video image capturing and preparation at the LG 8102 handset than at the Motorola A925. It is noted that playing back the received video images is less technically demanding than sending out video images. Because the Motorola A925 phone is slower in capturing and sending out images in a video call, this makes the delay in the 3G video call more obvious for video image captured by the Motorola A925 and played back on the LG 8120 handset.

Sound delay was also measured. In this case, the tester placed handsets in one room. The tester started the stop watch when talking to the first (transmitting) handset, and stopped the stop watch when sound come out from the second (receiving) handset's speaker. The tester utilized a hands-free earphone on the second handset, and covered the second handset's mouthpiece to reduce echo between the two handsets. Alternatively, hand-free headset can be connected to the two 3G handsets to cut off the standard sound input/output and reduce the echo significantly. It should be noted that measuring sound delay is less accurate than measuring image delay. It is further noted that the video call (image and sound) is synchronized even though it is delayed.

Testing like that described above was also utilized to provide the basis for analyzing the delay in a mobile-to-fixed 3G video call in using LG 8120 and Motorola A925 handset to call a PC or notebook PC. In this regard, video calls were placed from 3G handsets to PCs loaded with different anti-virus software and these tests will be further covered in the next section. Obvious improvement in the speed of receiving the video transmission was shown in a mobile-to-fixed 3G video call on a PC and a notebook computer running on a faster anti-virus software. NOD 32 is faster than Trend Micro PC-cillin and Symantec Norton Anti-virus, as shown by the reports given on NOD 32 website: http://www.nod32.com.hk/news/compare.htm

Reducine the Delay at Fixed-Mobile 3G/3.5G/4G Video Call

Real time video call between helper and handset user is needed because the helper may be advising the handset user to handle some dangerous tasks or items. Real time video call is definitely needed in the “police version” of the system. There is common experience that video call between 3G handset and PC (or IP phone) has delay, even though the image and voice are synchronized. That is, both the image and sound played on the PC (or IP phone) are not real time.

The delay on video call between 3G handsets is less obvious because the delay can be reduced to around 0.5 second (half a second) when the video call is made through better 3G handset models. To reduce this delay in mobile-to-fixed 3G video call to around 0.5 second (i.e. half a second), faster anti-virus software on PC (or notebook PC, wireless PDA, IP phone etc.) is proposed. To speed up the system server, blade servers of IBM or HP etc. is proposed as the hardware.

Delay at Video Call Between 3G Handsets and PCs Loaded with Different Anti-Virus Software is Tested with the Following Steps and Findings:

a) Motorola A925 handset or LG 8120 handset is placed close to the PC monitor, which is connected by video call to the Motorola A925 handset by webcall (between 3G handset and PC using Microsoft NetMeeting software) of Three Hong Kong;
b) the tester moves a finger over the Motorola A925 camera and the other hand start the timer at that moment. Then, the tester closely watch the PC and stop the timer once the finger image appear on the NetMeeting Windows at the PC. Time delay of the image appearing on the PC is consistently around 0.9 second in repeated measures for a PC loaded with NOD 32 anti-virus software as compared to 1.5 second delay when the same PC is running Trend Micro PC-cillin anti-virus software;
c) obvious improvement on the delay problem is seen at mobile-to-fixed 3G video call on a PC and a notebook computer running on a faster anti-virus software. NOD 32 is faster than Trend Micro PC-cillin and Symantec Norton Anti-virus, as shown by the software test reports given on NOD 32 website: http://www.nod32.com.hk/news/compare.htm;
d) the PC has an Intel Celeron 2.4G CPU and 256 MB RAM. The notebook has an Intel Pentium M 1 AG CPU and 256 MB RAM. Celeron CPU is weaker in processing video image than Pentium CPU. Therefore, the net processing power on video call (at NetMeeting) of the PC is close to the process power of the notebook

The above test findings are summarized in the following two tables which show 0.5 second or less delay at the mobile-to-fixed 3G video call is enabled by using the fastest anti-virus currently available at the market, namely it is NOD 32 Anti-virus. Windows XP firewall is used with NOD 32 Anti-virus in the testing, which also shows Windows XP firewall work efficiently on filtering video signals sent to NetMeeting on the monitoring device.

The delay of image and sound at mobile-to-fixed 3G video calls are shown in the following Table A and Table B. Variables in the following two tests include two PCs (different CPU and Memory), two 3G handset models (Motorola A925 and LG 8120), two anti-virus software (NOD 32 and Trend Micro PC-cillin), three webcams. The delay (in seconds) of image and sound at the fixed-mobile 3G video call is measured in seconds. The following tests are performed under 3 Hong Kong 3G network in January 2005.

A) Delay of Image and Sound at Mobile-to-Fixed
3G Video Call (under 3 HK network)

| | Motorola | Motorola A925 | | LG 8120 |
|---|---|---|---|---|
| | A925 | Trend | LG 8120 | Trend |
| | NOD 32 | PC-cillin | NOD 32 | PC-cillin |
| PC | 0.9 sec | 1.5 sec | 0.6 sec | 0.9 sec |
| (Celeron 2.4 G | | | | |
| 256 MB RAM) | | | | |
| Notebook | 0.9 sec | 2.0 sec | 0.5 sec | 1.8 sec |
| (Pentium M 1.4 G | | | | |
| 256 MB RAM) | | | | |

Interpretation of the Findings in the Above Table

e) Celeron 2.4G can process the anti-virus software faster than Pentium M 1.4G. This is important for processing anti-virus software with a slow scan engine. As a result, Motorola A925 obviously has less delay in working with Celeron 2.4G CPU. The above result is consistent with the previous test findings that Motorola A925 has slower processing speed on video call than LG 8120. As reflected from the above table, NOD 32 anti-virus and more powerful computer are more desirable to be used on monitoring device 18 (to receive 3G video call) in performing the “helper version” or “police version” of the alarm transmission system. A delay of 0.5 second is acceptable for most of the helpers. Some firewall and anti-spyware software will block the video image from going into the video conferencing software. Helpers may need to disable the firewalls or exit the anti-spyware from resident (active state) at the computer before they can receive the video image from the handset users. Symantec Norton Anti-Virus should cause a longer delay than Trend PC-cillin because Symantec has a slower scan engine, as shown by reports on: http://www.nod32.com.hk/news/compare.htm;

B) Delay of Image & Sound at Fixed-to-Mobile
3G Video Call (under NOD 32 anti-virus)

| Notebook | Motorola | Motorola | | | | |
|---|---|---|---|---|---|---|
| Pentium M 1.4 G | A925 | A925 | | LG 8120 | LG 8120 | |
| 256 MB RAM | Image | Sound | | Image | Sound | |
| Logitech | 0.9 sec | 0.5 | sec | 0.9 sec | 0.45 | sec |
| USB QuickCam | | | | | | |
| Hyundai | 1.2 sec | 0.55 | sec | 1.1 sec | 0.5 | sec |
| USB Web-Cam | | | | | | |
| BesTech | 1.8 sec | 0.6 | sec | 1.6 sec | 0.5 | sec |
| USB PC-CAM | | | | | | |

Interpretation of the Findings in the Above Table

Testing on Logitech QuickCam working with a PC (Celeron 2.4G CPU & 256MB RAM) shows that sound is delayed by 0.5 to 0.6 second, while video image is delayed by around 0.9 second for both Motorola A925 and LG 8120 handset. NOD 32 Anti-virus is also used in this testing.

The above testing results indicate that sound is not delayed in fixed-to-mobile 3G video call. The delay of first image showing on the 3G handset screen is affected by the speed of the web-cam working with the computer. Such testing results should be acceptable for most helpers in using “helper version” or “police version” of the system. This is because the helpers are giving advice or warning to the handset users at sites. The close to real time transmission of sound (in fixed-to-mobile 3G video call) ensures the helper's warning and instruction to handset user is only delayed by 0.5 second (half a second).

Recording Live Mobile-to-Fixed 3G/3.5G/4G Video Call

The alarm transmission system records the 3G/3.5G/4G video call, at server or at monitoring device, when the phone is making video call with the monitoring device or the helper communication device. Recording of video call at server is done by copying the H.323 or SIP (Session Initiation Protocol) signals sent to the monitoring device. The 3G-324M video call signals sent out by the 3G phone is first converted into H.323 or SIP signals, by a video gateway before sending out to the monitoring device (PC or IP video phone). Recording of video call at monitoring device is also done by copying the H.323 or SIP (Session Initiation Protocol) signals sent to the monitoring device.

Recording of video call at monitoring device is done by capturing the screen of NetMeeting or other video conferencing software at the monitoring device. Recording of the video call at almost all video conferencing software at the monitoring device can be done by screen capturing, especially at Windows and Linux platform. Screen capturing at monitoring device video conferencing software (e.g. NetMeeting) can be satisfactorily performed by a software called “Audio and Video Conference Recorder” (published by Virtual Desk), after comparing the performance of a few software. Recording of video call at monitoring device by screen capturing is done at “best video image quality” setting and “Microsoft Video 1” format. Recording of video call at monitoring device by screen capturing is best compressed by Windows Media Encoder (published by Microsoft), at Windows Media 8 format with 250 Kbps speed.

Recording of the video call does not delay the video call signals to monitoring devices and the phone. This is the ftindamental difference between recording live video call at the system and recording video at video mailbox.

Connecting Video Call to PCs Behind Commercial Firewall

Connecting 3G mobile video call to monitoring device (PC) behind firewall require fixed IP address on the monitoring device, which can be achieved by using true IP address, modifying the -software at DHCP (Dynamic Host Configuration Protocol) Server or using 3G data card to connect the monitoring device (PC) to Internet. Fixed virtual IP address can be assigned by DHCP server to the monitoring device behind firewall. NetMeeting and many video conferencing software working on Windows platform of the monitoring device (PC) requires fixed IP address for point-to-point connection between the parties in the video call. The dynamic (always changing) virtual IP address assigned by standard DHCP server will prevent video call connection to monitoring device behind firewall. Some plug-in software, at acceptable prices, can work on DHCP Server of many networks and assign fixed or static virtual IP address to the monitoring device, i.e. client PC.

Monitoring device (PC) can use dedicated line to connect to Internet and skip the firewall of the fixed network. In this case, true IP address of the monitoring device will be used to connect video call to the monitoring device. Monitoring device (notebook PC or PC) behind firewall can use 3G data card (PCMCIA card) to quickly skip the firewall of the fixed network. This is an option for monitoring device connected to complicated or large firewall, which require complicated internal approvals or expensive steps to modify its DHCP server.

Monitoring device using 3G data card (as broadband connection for video call) need to measure the delay at the video call, using the measuring method described in previous section.

Skipping Firewall of Fixed-Line Broadband Access by Using 3G. 3.5G or WiMax Data Card on PC

Monitoring device (PC), using 3G date card as broadband connection, will usually see stable delay at fixed-to-mobile video call but varying delay at mobile-to-fixed video call. Delay of image and sound at mobile-to-fixed video call has varying delay time, especially when the current UMTS cell is at the busy hours. 3G data card currently can reach 384 Kbps at the downlink (from 3G network to 3G data card) while the uplink (from 3G data card to 3G network) is 64 Kbps at most 3G networks currently. But, 3G data card downlink speed is slowed down more significantly by increasing number of 3G user in the current UMTS cell. This is because most 3G data applications are using the downlink rather than the uplink. Delay of image and sound at mobile-to-fixed video call is usually around 0.9 second (point nine second) when the current UMTS cell is not crowded. Delay of image and sound at mobile-to-fixed video call can lengthen to 1.5 second (one point five second) or more when the current UMTS cell is crowded.

Delay of sound at fixed-to-mobile video call can be kept at around 0.5 second (half a second). This is a software design on processing and sending out sound signals much faster than image signals at NetMeeting and most video conferencing software. Delay of image at fixed-to-mobile video call is usually at around 1.2 second and do not vary much by crowding at the current UMTS cell. This is because the uplink of the 3G data card not much affected. 3G handset and mobile operator video gateway both compress the video call signals before sending them out. But, NetMeeting and many video conferencing software on the monitoring device do not compress the video call signal as much as 3G equipments. So, we see longer delay of image at fixed-to-mobile video call than mobile-to-fixed video call, when the UMTS is not crowded. 3.5G—HSDPA (High Speed Downlink Packet Access) or HSUPA (High Speed Uplink Packet Access)—the data speed will be much faster and delay at video call using 3.5G data card. HSDPA can achieve downlink speed of over 3 Mbps and HSUPA can achieve uplink speed of over 1 Mbps.

3G data is around 384Kbps in uplink and 64 Kbps in downlink. It is found that 3G data card cannot meet the requirement of enabling 0.5 second or less delay at the fixed-mobile 3G video call. HSDPA, HSUPA, WiMax data card will be able to speed up the data transmission rate a lot. As a result, the delay in video call under these data card will be able to match the performance of fixed-line broadband access of 3 Mbps or above. At the same time, such data card will be able to support 0.5 second or less delay of image and sound at the video call.

The tests in the following two tables are done on LG 8120 3G handset calling NetMeeting on a notebook, using 3G data card (Merlin U530) on the notebook to access Internet and logon 3 Hong Kong (H3G) Webcall gatekeeper. The notebook computer has a Pentium M 1.4G CPU and 256 RAM memory, installed with NOD 32 Anti-virus, Windows XP firewall & Logitech Quick Cam.

C) Testing Time: 24 May, 2005 (Tue), 10:10
pm to 11:10 pm (at a residential area)

| | Mobile-to-Fixed | Fixed-to-Mobile |
|---|---|---|
| | (from LG 8120 | (from notebook |
| | to notebook) | to LG 8120) |
| Delay | 0.9 sec | 1.2 sec |
| in Image | (in many cases, | (stable delay) |
| | unpredictably vary | |
| | to 1.5 sec delay or more) | |
| Delay | 0.9 sec | 0.55 sec |
| in Sound | (in many cases, | (stable delay) |
| | unpredictably vary | |
| | to 1.5 sec delay or more) | |

D) Testing Time: 28 May, 2005 (Sat), 3:45
pm to 4:05 pm (at a residential area)

| | Mobile-to-Fixed | Fixed-to-Mobile |
|---|---|---|
| | (from LG 8120 | (from notebook |
| | to notebook) | to LG 8120) |
| Delay | 0.8 sec | 1.1 sec |
| in Image | (occasionally vary | (stable delay) |
| | to 1.2 sec delay or more) | |
| Delay | 0.9 sec | 0.5 sec |
| in Sound | (occasionally vary | (stable delay) |
| | to 1 sec delay or more) | |

Interpretation of the Findings in the Above Two Tables

Less variation at the delay of image & sound at mobile-to-fixed 3G video call is possibly due to less 3G users at the current UMTS cell. In addition, less 3G users at the UMTS cell will also make the data speed faster. So, the delay of image & sound at this fixed-mobile 3G video call is reduced in all cases (sound delay at mobile-to-fixed 3G video call is maintained at similar level as before).

As most 3G applications use the downlink, slowing down on downlink to 3G data card is more obvious when there are more 3G users in current UMTS cell. As a result, mobile-to-fixed 3G video calls show varying (& longer delay) while fixed-to-mobile 3G video calls only show stable delay. In other words, when there are few 3G users in one UMTS cell, the 3G data card downlink is always faster than its uplink. When 3G users increase in one UMTS cell, the 3G data card downlink can become slower than its uplink. So, varying & longer delay appears at mobile-to-fixed 3G video calls.

Uses of and Remarks on the Invention

“Police version” of the alarm transmission system can be used by law enforcement officer to guard against attack from the back when they are entering an dangerous situation. “Helper Version” of this alarm transmission system can be used by any mobile workforce, civilian of any age and handicapped people. “Consumer Version” of this alarm transmission system can be used by consumer who needs to walk through potentially dangerous area frequently and calling a helper may not be convenient.

Some uses of the alarm transmission system are further explained in details. It should be noted that the police, consumer or helper versions of the system of the present invention may be utilized to prevent criminal/terror activity. A person can send images, either still photos or video calls of possible criminal/terror activity from mobile device 12, to server 14—and ultimately to rescuer control room email terminal 15 and then to device 16. Law enforcement officials or helpers can provide assistance to individuals in trouble by giving them advice on how to handle a certain situation the person may be experiencing. Moreover, if the perpetrator becomes aware that recording of his/her image is occurring, the perpetrator may decide to leave the scene rather than to commit a criminal act that could be recorded. Even if the individual becomes a victim of a criminal act, the perpetrator's images will have been sent to law enforcement, and this may lead to the capture of the perpetrator.

The system may also be designed, particularly in the consumer version, to prevent the misuse of the mobile device 12. Presently, some individuals are using camera phones and other small digital camera devices to take voyeur pictures of unsuspecting people. Voyeur pictures are illegal in many jurisdictions. Since all images taken by the mobile device 12 are recorded by the server 14, there will be documented evidence of any illegal pictures taken by the mobile device 12. Thus, individuals will be discouraged from taking any type of illegal images.

With respect to the police, consumer, and/or helper embodiments herein described, it may be desired to have video transmissions from a particular mobile device 12 saved to a designated account file at the server 14. The images may be deleted from the account file on a periodic basis (i.e., once a week, once a month, etc.).

The speed of transmission of the video calls is important to the effectiveness of the various embodiments of the present invention. It is thought optimal to have a delay of less than one second, and preferably of 0.5 seconds or less, between capturing of an image by a mobile device 12 and its receipt at a monitoring device 18 or helper device 20. Improving speed of transmission involves software and hardware pertaining to the various system components, as described more specifically in the above sections.

It is noted that some IT professionals believe that speeding up this process would be based on providing a faster data transmission rate at the 3G mobile network by, for example, upgrading to 3.5G (HSDPA), 4G or Super 3G. But, such thinking is wrong. As shown above, tests conducted by the inventor show that mobile network transmission can be sufficiently fast even utilizing a 3G handset transmitting a video call to a PC.

Novelty of this invention includes, but not limited to:
1. An alarm transmission system and alarm transmission method based on video call (real-time on-site video images), which are enabled by the emerging technologies in fast data transmission rate mobile network.
2. An easy-to-use and inexpensive testing system and method to measure the delay at mobile-mobile and fixed-mobile video call. This testing system and method allows quickly available comparison on the performance of equipments used in video call, which include: mobile device, server, mobile network, monitoring device, software used on the monitoring device and server.
3. Identifying anti-virus software at the fixed video call terminal (PC) is the key element in the 2 seconds or more delay at fixed-mobile video call experienced currently rather than the mobile network, opposing many IT people's general thinking.
4. A simple and inexpensive solution to reduce the delay at fixed-mobile video call to 0.5 second by installing the fastest anti-virus software at the monitoring device (including PC, client PC, notebook, IP softPhone etc.). Currently, NOD 32 Anti-virus is the fastest anti-virus software.
5. An easy-to-use and quickly installed solution to enable PC behind complicated firewall to connect video call with video terminals outside the firewall, e.g. mobile phones or PCs
6. Simple recording software based on screen capturing to record video call and efficient compression on the recorded video call.

While the invention has been particularly shown and described with reference to preferred embodiments thereof, it will be understood by those skilled in the art that the foregoing and other changes in form and details may be made therein without departing from the spirit and scope of the invention.

1. An alarm transmission system for summoning assistance in response to a problematic situation, comprising:
a mobile device for transmitting a video call of the problematic situation;
a server in communication with the mobile device, which receives and records the video call from the mobile device, and then hunts and connects an available monitoring device from a list of pre-defined monitoring devices;
a list of pre-defined monitoring devices, one of which receives the video call from the server that was originally transmitted by the mobile device, and instructs the server to send the recorded video call and photos to a rescuer control room email terminal;
a rescuer control room email terminal, which receives the recorded video call and photos sent by the server; and
a rescuer communication device, which receives the recorded video and photos from the rescuer control room email terminal that were originally transmitted by the mobile device.

2. The system of claim 1, wherein the mobile device has a location based service thereon.

3. The system of claim 1, wherein the mobile device is carried by a law enforcement officer or a civilian.

4. The system of claim 1, wherein the mobile device has:
a video call processing power which enables 0.5 second or less delay at the video call;
a data uplink speed which enables 0.5 second or less delay at the video call; and
a camera which takes video images for the video call.

5. The system of claim 1, wherein the mobile device is connected to the server by a mobile network, which enables high speed data transmission for supporting video call in areas where the mobile device is used and allows the mobile-to-fixed video call with delay of 0.5 second or less.

6. The system of claim 1, wherein the server has:
a recording software which copies the video call signals while the video call is transmitted to the monitoring device, and causes 0.2 second or less delay of video signals in transmitting video call;
an anti-virus software or hardware which enables 0.2 second or less delay of the video call signals in transmitting the video call;
a firewall which enables 0.2 second or less delay of the video call signals in transmitting the video call.

7. The system of claim 6, wherein the server has an IP PBX function to hunt and connect an available monitoring device from the list of pre-defined monitoring device for the mobile device.

8. The system of claim 6, wherein the recording software, when copying the video call signals, works with a mobile-to-fixed video gateway at a mobile network operator, with a web server at a web-based video call, or, with a video conference gatekeeper at an IP based video call.

9. The system of claim 1, wherein the monitoring device is a PC, a client PC, a notebook PC, an IP softPhone, or, an IP video phone.

10. The system of claim 1, wherein the monitoring device is further provided with a function of recording the video call while assistance is provided via the monitoring device to the mobile device, as an alternative device to perform the recording video call function of the server.

11. The system of claim 1, wherein the monitoring device is replaced by a helper communication device, which has same function as the mobile device carried by a civilian.

12. The system of claim 1, wherein the monitoring device has:
a camera which takes video images for the video call;
an anti-virus software which enables 0.5 second or less delay at the video call;
a firewall which allows a video call stream to reach the monitoring device and enables 0.5 second or less delay at the video call;
a video conferencing software which holds the video call;
a CPU which enables 0.5 second or less delay at the video call;
a memory which enables 0.5 second or less delays at the video call;
a broadband Internet access which enables 0.5 second or less delay at the video call.

13. The system of claim 12, wherein the monitoring device further has a recording software which copies video signals of the video call sent to the monitoring device, with delay of 0.5 second or less at the video call.

14. The system of claim 12, wherein the recording software enables capturing screen of the video conferencing software and recording the video call sound signal by capturing the sound track of the monitoring device, with delay of 0.5 second or less at the video call.

15. The system of claim 14, wherein the recorded video call is compressed to reduce the size of the recorded video call, and frames of the recorded video call are compressed and extracted to still photos, before the recorded video call and frames are sent out.

16. The system of claim 12, wherein the anti-virus software has a fast virus scanning rate as measured by executable throughout KB/sec or fast virus scan time (sec) on executables, reaching:
a virus scanning rate of executable throughput at 7000 KB/sec or above;
a virus scan time of 39 seconds or below on executables;
a virus scanning rate of executable throughput at less than 7000 KB/sec but still enables 0.5 second or less delay at the video call; or
a virus scan time of more than 39 seconds on executables but still enable 0.5 second or less delay at the video call.

17. The system of claim 12, wherein the firewall enables the video call signals to reach the video conferencing software, with 0.5 second or less delay at the video call at the monitoring device, and allows a fixed virtual IP address or true IP address to access the Internet.

18. The system of claim 12, wherein the broadband Internet access is based on a wireless broadband access, wireless WAN (Wide Area Network), or a fixed-line broadband access, using a true IP address or fixed virtual IP address to access Internet, allowing:
1 second or less delay at the video call when the broadband access can achieve a data rate of 384 Kbps;
1 to 0.5 second delay at the video call when the broadband access can achieve a data rate between 384 Kbps and 3 Mbps; or
0.5 second or less delay at the video call, when the broadband access can achieve a data speed of 3 Mbps or more.

19. An alarm transmission system for summoning assistance in response to a problematic situation comprising:
a mobile device for transmitting video calls of the problematic situation;
a server in communication with the mobile device, which receives and records the video calls from the mobile device;
an interactive voice response system, which is in communication with the server and the mobile device, and which instructs the server to send the recorded video call and photos to a rescuer control room email terminal;
a rescuer control room email terminal, which receives the recorded video call and photos from the server that were originally transmitted by the mobile device; and
a rescuer communication device, which receives the recorded video call and photos from the rescuer control room email terminal.

20. The system of claim 19, wherein the mobile device has a location based service thereon.

21. The system of claim 19, wherein the mobile device is carried by a civilian.

22. The system of claim 19, wherein the interactive voice response system and recording video call function are combined together in the same way that a three-party video conference is held on the mobile device, with first party as mobile device and the other two parties as the recording video call system and the interactive voice response system.

23. A method for transmitting an alarm, comprising:
enabling transmission of video calls from a mobile device to a server;
enabling receiving and recording of the video calls by the server;
enabling hunting and connecting an available monitoring device from a list of pre-defined monitoring devices by the server for the mobile device;
enabling transmission of the video call from the server to the monitoring device;
enabling transmission of the recorded video call and photos from the server or the monitoring device to the rescuer control room email terminal, following action by the monitoring device; and
enabling transmission of the recorded video call or photos from the rescuer control room email terminal to the rescuer communication device.

24. The method of claim 23, further comprising enabling communication between the mobile device and the rescuer communication device.

25. The method of claim 23, further comprising enabling determination of a location of the mobile device and communicating the location to the rescuer communication device.

26. The method of claim 23, wherein the mobile device is carried by a law enforcement officer

27. The method of claim 23, wherein the mobile device is carried by a civilian.

28. The method of claim 27, wherein the civilian registers the list of pre-defined monitoring devices or helper communication devices with an operator of the server.

29. A method for transmitting an alarm, comprising:
enabling transmission of video calls from a mobile device to a server, enabling recording of the video call by the server;
enabling communication between an inter-active voice response system and the mobile device through the server, following the transmission of video calls from the mobile device to the server,
enabling transmission of the recorded video calls and photos to a rescuer control room email terminal, following action by one of the mobile device and the inter-active voice response system; and
enabling transmission of the recorded video call and photos from the rescuer control room email terminal to a rescuer communication device.

30. The method of claim 29, comprising facilitating communication between the mobile device and the rescuer communication device.

31. The method of claim 29, further comprising enabling determination of a location of the mobile device and communicating the location to the rescuer communication device.

32. The method of claim 29, wherein the mobile device is carried by a civilian.

33. The method of claim 29, further comprising enabling the inter-active voice response system to prompt the user of the mobile device to for a password to be entered once or multiple times.

34. The method of claim 29, further comprising enabling transmission of recorded video call and photos to the rescuer control room email terminal when at least one of a wrong password is entered in response to the prompt or no password is entered in response to the prompt.

35. A testing system for measuring the delay at the video call of the system of claim 1 at a location where the system is used, comprising:
a sending-video-call-signal device, selected from the group consisting of a test mobile device or a test monitoring device;
a receiving-video-call-signal device, selected from the group consisting of a test mobile device or a test monitoring device;
a test network, which is a network to be tested before it is used in the system of claim 9;
a test server, which is a server to be tested before it is used in the system of claim 1; and
a stop watch, which measures to 0.01 second.

36. The testing system of claim 35, wherein the test mobile device is modified from a mobile device of the system of claim 1 by plugging a hand-free headset to earphone socket of the mobile device, or, connecting a wireless headset to the mobile device.

37. The testing system of claim 35, wherein the test monitoring device is modified from a monitoring device of the system of claim 1, by:
connecting a earphone to the monitoring device of the system of claim 1 so that sound output of the monitoring device is channeled to the earphone;
connecting a small microphone to the monitoring device of the system of claim 1 so that all sound input of the monitoring device is channeled to the small microphone, or,
plugging an earphone to a microphone socket of the monitoring device of the system of claim 1 so that the sound input of the monitoring device is totally cut off.

38. A method for measuring the delay of video image at a video call using the testing system of claim 35, which comprises:
placing the sending-video-call-signal device and the receiving-video-call-signal device close to each other;
moving an item in front of the camera of the sending-video-call-signal device;
pressing the start button of the stop watch when the item is moved in front of the sending-video-call-signal device;
watching the screen of the receiving-video-call-signal device;
pressing the stop watch of the stop watch when the item appears on the screen of the receiving-video-call-signal device;
marking down the reading shown on the stop watch;
resetting the stop watch to zero;
repeating the above steps a number of times until pressing of the start button of the stop watch exactly matches the time when the item is moved in front of the sending-video-call-signal device, and, pressing of the stop button of the stop watch exactly matches the time when the item appear on the screen of the receiving-video-call-signal device;
averaging out ten stable readings marked down from the stop watch; and
treating the average as the delay of video image at the video call.

39. A method for measuring the delay of sound at video call using the testing system of claim 35, which comprises:
placing the sending-video-call-signal device and the receiving-video-call-signal device close to each other;
plugging the earphone of the receiving-video-call-signal device at one ear;
putting aside the microphone of the receiving-video-call-signal device, or, turning off the microphone of the receiving-video-call-signal device;
holding the microphone of the sending-video-call-signal device near the mouth;
putting aside the earphone of the sending-video-call-signal device;
saying a simple word close to the microphone of the sending-video-call-signal device;
pressing the start button of the stop watch when the word is said to the microphone of the test mobile device;
hearing this simple word from the earphone of the receiving-video-call-signal device;
pressing the stop watch of the stop watch when the simple word is heard from the earphone of the receiving-video-call-signal device;
marking down the time shown on the stop watch;
resetting the stop watch to zero;
repeating the above steps a number of times until pressing of the start button of the stop watch exactly matches the time when the simple word is said to the microphone, and, pressing of the stop button of the stop watch exactly matches the time when the simple word is heard at the earphone;
averaging out around ten stable readings marked down from the stop watch; and
treating the average as the delay of sound at the video call.
